(19) United States
(12) Patent Application Publication
(10) Pub. No.: US 2017/0193165 A1
(43) Pub. Date: Jul. 6, 2017

(54) METHOD AND SYSTEM FOR MANAGING PATIENT HEALTHCARE PROGNOSIS

(71) Applicants: Sastry Subbaraya Mandalika, Richmond, VA (US); Palash Bharadwaj, Lathrop, CA (US)

(72) Inventors: Sastry Subbaraya Mandalika, Richmond, VA (US); Palash Bharadwaj, Lathrop, CA (US)

(21) Appl. No.: 15/396,171

(22) Filed: Dec. 30, 2016

Related U.S. Application Data
(60) Provisional application No. 62/273,325, filed on Dec. 30, 2015.

(51) Int. Cl. G06F 19/00

(52) U.S. Cl. CPC G06F 19/322; G06F 19/3418; G06F 19/3431; G06F 19/328; G06F 19/363

(57) ABSTRACT

The disclosed system consists of web and mobile applications, engaging healthcare all stakeholders in healthcare to continuously collect the data, monitor, intervene and learn to predict and prevent the incidents which is avoidable and can make the care quality superior and available to all sorts of patients; young or old and near or remote. This helps the care more transparent, easily accessible and cost effective. This solution provides greater focus on value from the entire healthcare system, by increasing need to activate responsible citizens, by experimenting new approaches to promote health and delivering better and continuous care to overcome growing resource challenges. Current application platform focuses on Cardiac and other related comorbid chronic diseases. The solution also helps healthcare to move to secure digital information to provide better care delivery with evidence based knowledge through, shared, accessible, secured clinical decisions at the point of care.

### CROSS-REFERENCE TO THE RELATED APPLICATIONS

This application claims the benefit of U.S. Provisional Patent Application No. 62/273,325 field Dec. 30, 2015, the disclosure of which is incorporated herein by reference.

### FIELD OF THE INVENTION

The presently disclosed subject matter relates to system and methods for managing the patient care and recovery. More particularly, the disclosed subject matter relates to a comprehensive healthcare management system for real-time of screening patients for one or more vitals and healthcare status. This comprehensive healthcare management system will aid patients in their complete recovery from the disease and will create a pathway for employing a predictive and/or preventive care approach to achieve healthcare prognosis.

### BACKGROUND OF THE INVENTION

The healthcare system at large is becoming expensive and as a result, most countries around the world are being forced to allocate more and more of their Gross Domestic Product (GDP) towards healthcare. With regard to the United States of America, the national spending on healthcare is expected to increase in near future as the population is aging, which correlates to an increase in the rates of morbidity and comorbidity for non-communicable diseases. The most concerning are cardiovascular diseases (e.g., heart disease, heart attack etc.,).

Although these diseases remain difficult to completely prevent or recover, an early detection (e.g., through predictive approach), proper medical intervention (e.g., through assessments, alerts, engaging) are important to reduce the risk of aggravating, progression of diseases, making changes to lifestyle, keeping patients in their comfort zone (e.g., at home) and creating environment for path to recovery to occur.

Another concern is how to provide a reasonable health care to the new or already discharged patients from areas far away from the specialized hospitals and healthcare providers. Many countries, irrespective whether they are developed or under developed, as per WHO (World Health Organization) estimates, have a large in patient-to-doctor and patient-to specialist ratios.

The currently available healthcare systems are not providing a complete solution to address challenges in healthcare quality. Further, the current healthcare system fails to gather meaningful data, detect, diagnose, predict, prevent or treat heart diseases. This is mainly happening as the heart disease cure or prevention is based on many physiological, living habits occupational and behavioral practices. Even though there are several guidelines available for all practices from their respective professional bodies, there exists no unified method to elevate the usefulness and benefits of these individual guidelines.

Present health care systems also falls short in providing effective communication between the practices, patients, their attendants/family members, and healthcare providers. This communication gap exacerbates when attempting to address or perform a correlation effects for the cause of comorbidity scenarios. Individual care provided at different locations is often unrelated and difficult to obtain at current point of care for patient treatment, which may lead into inefficiencies and lapses in patient care, which, in turn, may also lead to medical mistakes, increased costs and inconveniences to patients, family, and enhanced care related costs to all disbursing stakeholders.

There exists a need to have a better health care system to predict, manage and treat the patient: by having better communication among all stakeholders and by collecting and storing meaningful data for the goal of gathering effective treatment plans. This new system will improve healthcare quality, reduce the costs associated for quality healthcare and allow respective governments to plan for the adequacies needed for providing quality healthcare.

Further, in the existing model of healthcare, performed as specialty and discrete services, for any chronic disease silos, including cardiac care, through any provider solution, there is no learning and evidence based decision-making method and the care by one provider to another provider can vary. The knowledge base is not utilized or even changed based on scenarios and need. This is more important as the world population migration may increase in near future, which is currently at a slow pace. This process can even make the beneficiary go through unknown facts and can cause more costs and repetitive generic care model, decreasing the quality of healthcare. This may increase the burden for the healthcare payers.

Furthermore, the concerned departments (e.g., WHO, USHHS, other regulatory agencies) are employing the rules and guidelines in control of quality of care, healthcare data privacy and readmission criteria, to name a few, for the providers and professional to follow through. This has even increased the provider costs to meet the guidelines with the employment of distributed tools and services.

Another challenge for the regulators (e.g., FDA and NIH) is control of the quality of medicines, whether a new drug or already existing. This is required to know the drug safety, efficacy and dosage. To reduce the nature of comorbidity to other major diseases, having a continuous real-time vitals data would increase the drug usage safety and reduce the risks of comorbidity.

There is a need for patient healthcare management system for achieving near complete care prognosis, with greater real-time communication between all involved in care, collecting managing meaningful data, access and distribution of relevant information and data with security, thus creating an environment to improve satisfaction to all stakeholders, keeping patient healthcare prognosis as primary focus.

For the reasons stated above there is a need to have solution which works like automated integrated system, method and platform which is tailored to collect data from patients in both active and passive way, wherever they are, and generate several reports on trends in all biological functions, correlations between vitals, physiological, psychological, diagnostic, prescriptions of current and past. The providers can use the data and reports to realize benefits such as reduced readmissions, shortened hospital stay, improved clinical outcomes at reduced costs, provision of training to the specialists, to provide satisfaction to the patients and helping the drug discovery and clinical trials.

### SUMMARY

The disclosed subject matter in it's several embodiments provides the software platform and solution for Cardiac patients who are discharged from hospital or in the pathway to recovery from other alignments, living at home or other location with commuting to professionals during regular long interval visits or from a remote place, with a real time continuous data, with the workflow management for the health care professionals and service providers complying with HIPAA regulations, and various Health Care protocols and interfaces—HL7 (Health Level 7), HEDIS (Healthcare effectiveness data and information set), flat file data exchange format and protocols, drug usage records, present and past diseases or problems that was found for each patients, collecting patient selected vitals as per care guidance, with selected time interval based on prognosis pattern, system generated alerts based on the thresholds set by providers and converting the normal way of treating or providing care by every time visit to doctor, to software based documented data based predict and prevent at patients comfort level with reduced costs and increased quality.

The solution interfaces in the real-time data collection through measuring equipment's (Weighing scale, Blood pressure measurement equipment etc.) through the Bluetooth enabled mobile devices and processes, data using filtering and correlation algorithms for meaningful use of clinical and other physiological and psychological data, in order for healthcare professionals to get alerts based on their parameters defined for each individual patients under the program within the system, provide the necessary intervention needed remotely in general with a schedule to have minimal personal visits.

Where necessary the healthcare professional can select to have the patient on demand call for changed instructions, submit lab tests request, reviews the set time reports from the system and laboratory submitted reports to provide complete care. Healthcare professionals have a facility to entrust, engage, guide other professionals, nursing, social workers as needed within the system and access their opinions and reports to assess the status of healthcare.

In overall, the disclosed solution provides high quality secured, advanced, cost effective total healthcare information to improve the quality of healthcare by real-time remote health monitoring, while connecting and communicating with patients.

### BRIEF DESCRIPTION OF THE DRWAINGS

To provide complete understanding on features and advantages of the disclosed subject matter, a brief reference is made to the following description on submitted drawings:

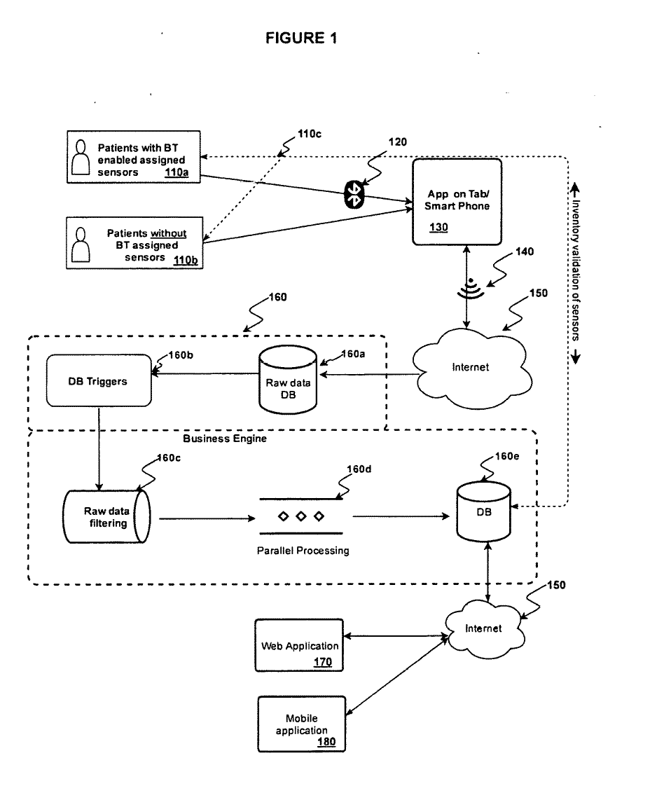

FIG. 1 illustrates high-level process flow for real-time remote patient monitoring that is suitable for practicing the embodiment of present invention.

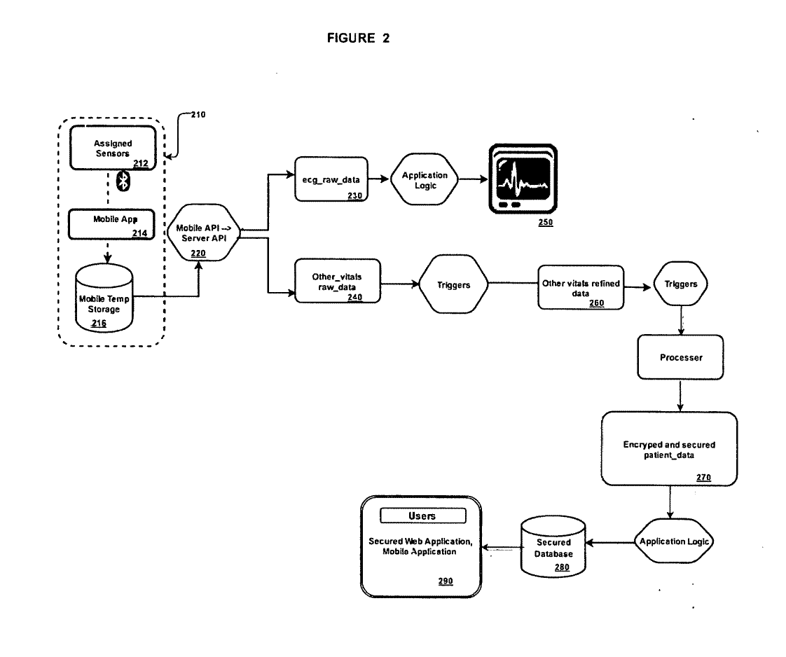

FIG. 2 illustrates functional structure for real-time patient cardiac health data capture on mobile application according to some embodiments of the disclosed subject matter.

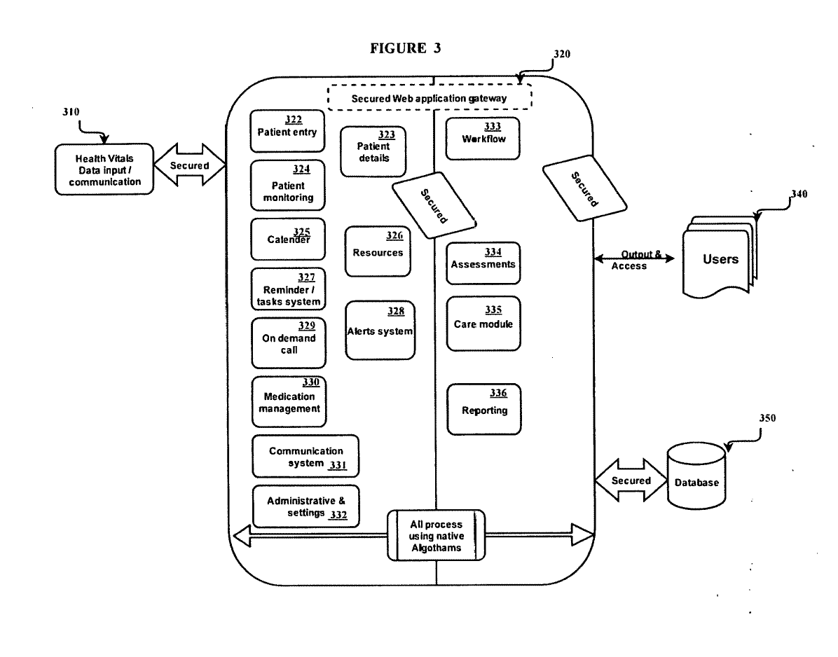

FIG. 3 illustrates functional structure and process for real-time data on web application according to some embodiments of the disclosed subject matter.

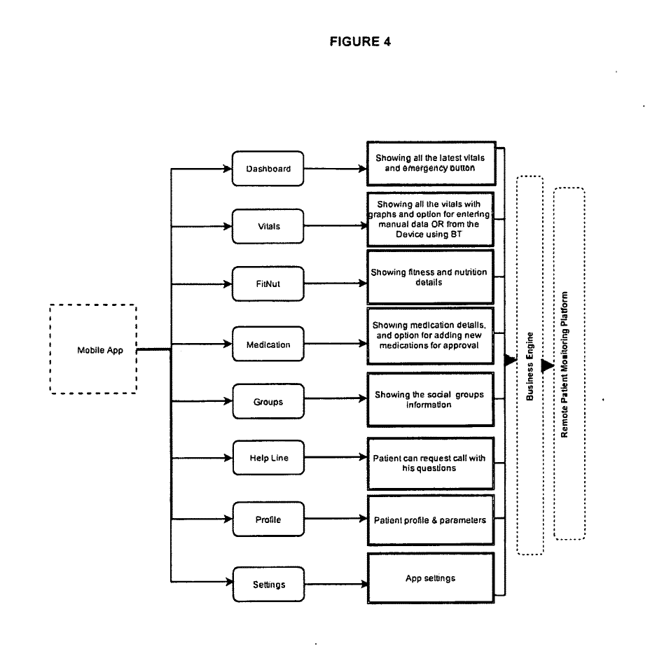

FIG. 4 illustrates process functions on the mobile application according to one embodiment of the disclosed subject matter.

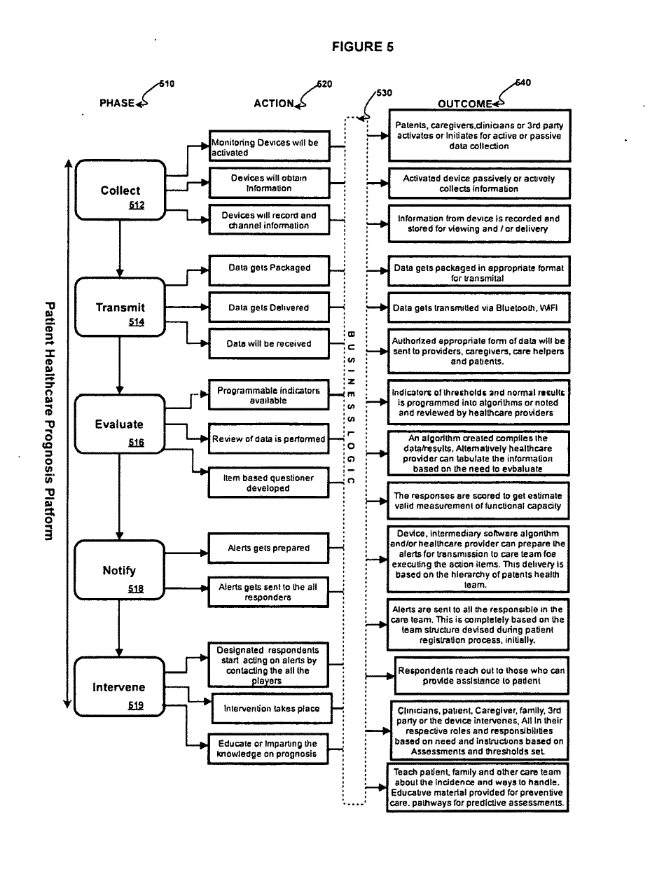

FIG. 5 illustrates a process for the management and prognosis of patient healthcare according to some embodiments of the disclosed subject matter.

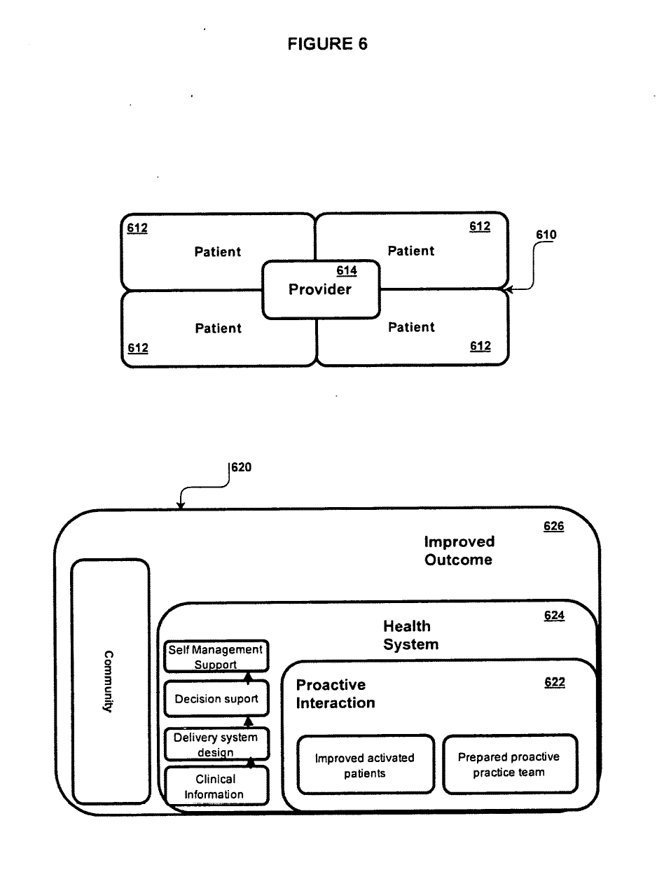

FIG. 6 illustrates progression of healthcare models from existing to proposed as per disclosed subject matter.

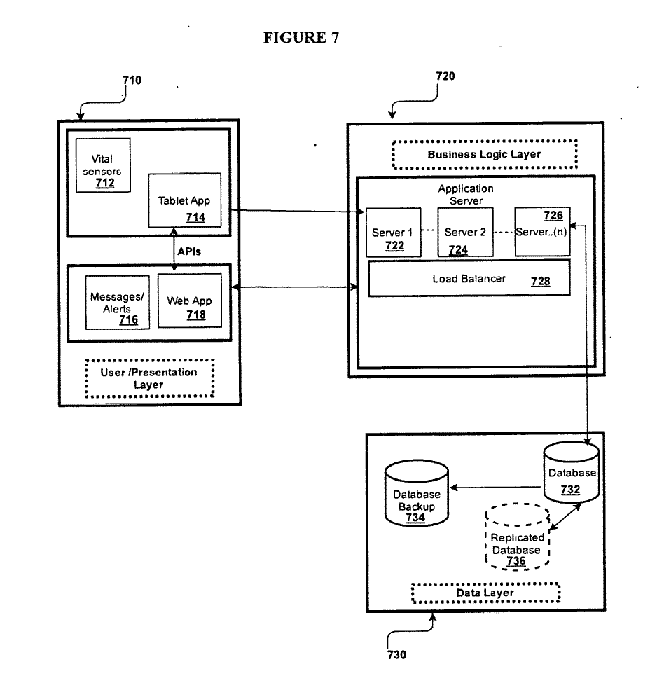

FIG. 7 illustrates high-level architecture of a real-time remote patient monitoring system according to some embodiments of the disclosed subject matter.

### DETAILED DESCRIPTION

In the following detailed description of the preferred embodiments, reference is made to the accompanying drawings that form a part hereof, which are shown by way of illustration specific embodiments in which the invention may be practiced. The other embodiments may be utilized and structural changes may be made without departing from the scope of present disclosed subject matter.

The disclosed subject matter provides methods and systems for managing patient healthcare prognosis. The methods and systems include, among others, selecting vitals to collect for recovery process or prediction or prevention of cardiac disease, whether arising direct or in comorbid nature, analyzing the real-time continuous patient vitals for creating a personalized healthcare plan for patient and healthcare team to follow, providing treatment options with regular communications through the system, accessing to regular reports based on the exigencies of nature of patients healthcare, accessing vital alerts, reacting, advising the care team in changes to healthcare management plan and/or other recommended course of actions based on current and history of vitals recorded to address the core issue of patient healthcare prognosis from the diseases.

In the currently disclosed subject matter a method for management of healthcare is provided. Firstly, a patient discharged from hospital or already on the recovery path or practitioner advises based on family healthcare history or a patient or group of patients or control group going through the clinical trials and/or patients from other scenarios as identified by the healthcare practitioner are registered and a complete profile is created. The practitioner then assigns vitals to get monitored based on the current condition of patient, threshold levels and vitals data collection intervals are suggested. The care team then prepares the selected vitals sensors and secures data collection kits by carefully integrating each component. The patient will get necessary training and education on the usage of kit, adherence to the care plan. Patients will get the support and guidance from the care team when necessary and on regular basis comprising, but not limited to, nurses, social worker, nutritionist, activity and patient approved family members. The profiles get automatically updated with the then current results and healthcare management plan along with all vital records, graphical representations, and medication, with other behavioral and lifestyle patterns. Healthcare practitioner can draw the inference from the past data for correlations at any point of time, on secure web or mobile application. Patients may be grouped as per requirements of Healthcare practitioner or care team or drug discovery team or clinical trial group and/or phases and payer or control or regulatory authorities internal rules, regulation and operating exigencies.

According to another aspect of currently disclosed subject matter, a system for management of patient healthcare prognosis is provided. The system consists at least one memory unit to store the data, results and reports, and at least one processing unit coupled with at least one memory unit. Further the system consists at least one health vital collecting sensor, which in turn integrated with a mobile unit through Bluetooth (BT) for communication and connects to processing and memory unit through internet. The processing unit may comprise at least one or more business logic or triggers or algorithm to collect vitals data for the registered patient, perform filtering the data as per the stipulated guidelines, presentation of the data, perform drawing correlations at least one combination of results or disease pattern, perform mechanism of healthcare prognosis of patient based on at least one result, generating the reports comprising at least one test or result, requesting and collecting the at least one external test and results, perform at least one inventory validation of assigned vital sensors, transmit at least one set of data in secure way, perform review and evaluation of data, perform at least one item based questioner developed and results gathered, perform notification of alerts based on data, allow the role based intervention to at least one alert or notification, perform education and training to at least one user on the at least one aspect of healthcare prognosis pathway, perform when necessary at least one call either video or audio to help patient and healthcare practitioner or care team understand and evaluate the status of alert and providing a recommended action based on, status of healthcare management and complete current status of health.

The features, structures or characteristics of currently disclosed subject matter throughout this specification may be combined in any suitable manner in one or more embodiments. For example, reference throughout this specification to “certain embodiments” or “some embodiments” or “one aspect” of current disclosure or similar representation means that particular feature or structure or pattern in connection to the embodiment or aspect is included in at least one embodiment or aspect in the current disclosed matter or present invention. Thus the representations of phrases like “in certain embodiments” or “in exemplary embodiment” or “in some embodiments” or any similar presentations throughout this specification do not necessarily refer to same group of embodiments or described features and described features and characteristics may be combined in any suitable manner in one or more embodiments.

For the purpose of illustration and without limitation, FIG. 1 illustrates high-level process flow for real-time remote patient monitoring that is suitable for practicing the certain embodiments of present invention. At 110a and 110b the registered patients are assigned with sensors for collecting vitals whether with or without Bluetooth access, as per the patient profile and assessment of the healthcare practitioner. The sensors are integrated with mobile app on tablet shown at 130 for creating the security feature. The sensor and tablet now will become as set and get validated with the inventory portion of the database, primary memory unit, represented at 160e. When patients on wearing the sensors the collected data will get transmit to the mobile app through Bluetooth connection, if the sensors are enabled with Bluetooth, in case the sensors are not having Bluetooth feature then the data will have to be entered manually by the user and such data record will be clearly identified as manual entry in the records. Thus collected data at 130 will be transmitted to raw data base 160a through location based wife 140 and internet 150 connectivity. Thus collected raw data will pass through database triggers 160b to get filtered at 160c and get processed in a parallel processor 160d for each assigned sensor or vital and stored in respective tables in relational database 160e. All the processes from 160a -160e are performed in secured cloud-based environment, collectively called as business engine, shown as dashed line box 160. The store refined processed data from 160e may be securely shared or presented to all users be it on web application 170 or on mobile application 180, within their assigned role based access, through internet 150. Certain data requests for reports, assessments, communication notes, medication changes or healthcare prognosis plan changes and thus generated reports for management of patient healthcare prognosis may originate from web application 170 or mobile application 180 via internet 150 to database 160e and records are stored. The primary memory, web application system (not shown in figure) holds and run currently on Windows operating system environment (not shown in figure). The present disclosed subject matter related application might also run on other computing environments. The tablet or mobile system holds and run on Android operating system environment.

Those skilled in the art will appreciate and understand that the process flow and other environment shown in FIG. 1 intended to be merely illustrative. A high-level architecture diagram is shown separately in FIG. 7.

FIG. 2 illustrates functional structure for real-time patient cardiac health data capture on mobile application according to some embodiments of the disclosed subject matter. The mobile application is aimed at integrating all the assigned sensors together and securely collects and transmits the data, to maintain the Health Insurance Portability and Accountability (HIPAA) guidelines, provide temporary storage for the data, for example, in the event of non availability of internet at patients place, when patient is travelling and to have other features to data input, collect, communicate and view of alerts, results, to-do actions, scheduler, reports.

In FIG. 2 at 210 illustrates assigned sensors 212 communicating to temporary storage 216 via mobile app 214. The application may have the ability to extract data from all the assigned sensors at assigned time intervals or continuously. The sensor selection is based on the patient condition and at the discretion of healthcare practitioner, for example, generally, in cardiac care, the vitals sensors to following vitals may be selected;
Temperature
Heart rate
Electrocardiogram, with concentration on tachycardia, bradycardia or generally arrhythmias among other assumptions
Blood pressure, concentration rapid changes in systolic and diastolic among other assumptions
Weight, with concentration on rapid changes in weight
Oxygen (SPO2) to understand on saturation level and indirectly on functions of other body systems and other
Sleep, mainly to know on sleep patterns, sleep apnea apart from other indications
Activity, to study on burning on calories, stress related exertions, cardio reactions, apart from other
Blood Glucose

The mobile application as shown in FIG. 2 data from the temporary mobile storage 216 get transmitted to 220 which will have mobile/server Application Program Interface (API) on request, the continuous data from electrocardiogram or heart rate sensor raw data 230 is may be refined and application logic will convert the meaningful data to graphical electrocardiogram shown at 250. The electrocardiogram thus generated with time stamp will get stored in the database, with respective data files, for further retrievals and reports. Data from other sensors will pass through the refined 260 and pass through assigned vital based generated triggers to process. Thus generated patent data is encrypted and secured 270, based on the application logic and the pattern of healthcare prognosis management plan employed by the healthcare practitioner the data is segregated or grouped and sent for storage in primary secured database 280. The data and corresponding information generated based on the query of the user based on the role based assignments securely gets transmitted to secure web or mobile application.

Users 290 of the system may be;
Healthcare practitioners
Nurses
Other care team members, nutritionist, activity trainers,
Hospitals, Nursing homes, clinics, home healthcare services
Assisted living centers, Independent living centers, Old age homes
Rehabilitation centers and other health related patient oriented service providers
Clinical Trial establishments, Drug discovery groups
Government Health Agencies and Regulators
Patients assigned to the system, patients family members approved by patient

FIG. 4 illustrates process functions on the mobile application according to one embodiment of the disclosed subject matter. The FIG. 4 is not having the reference number as the functions are explained. The dashed blocks represented for understanding of already explained system functions at FIG. 2. The dashboard shows all active and latest vitals information with alerts and actions, communication, profile and assigned parameters. Where the data is connected through Bluetooth, manual entry options are provided. Fitness, activity, and nutrition details likes set goals and achievements are shown. Calorie intake, water intake, food label inputs are allowed to feed into the system. The system uses this information to generate reports and assessments for differences with set goals and calorie burn, quality and amount of sleep patient had. The mobile application also has function to show medication details and option to add new medication for approval of their healthcare practitioner/provider. Patients can communicate with their related group through social group option, for example, to have helping hand in picking medication from store or to share their problem, if alone or family is in far off place, or incase of patients are having any complications, which family needs to know for support, healthcare practitioner may communicate about such prognosis complexities. Application settings for view and operation may be managed through the settings function.

FIG. 3 illustrates functional structure and process for real-time data on web application according to some embodiments of the disclosed subject matter. The health vitals data, which is collected by the mobile application, is securely transmitted in parallel to secured web application 320. The web application is also having workflow similar to mobile application, with patient data entry 322. The patient details 323 related to demographics, like age, gender, ethnicity, family medical history, medication history, address, current and past lifestyle, food habits, assigned healthcare practitioners, care team. Based on the patient details and consultations with patient, the healthcare practitioner proposes a care methodology for healthcare prognosis for the patient and assigns the vital needed to be monitored 324 for assessment.

All the schedules and to-do list will get communicated and presented on the system for patient and care team to follow at calendar 325. All the patient education on the prognosis process, diseases, precaution to control comorbidities and fitness, nutrition related information is made available under resources 326, it also carries patient specific and disease centric survey questioner form care team to record the reactions and progress been made by the patient. All questions are graded to compute health score over a period of time and the same is incorporated in the reports. Patient gets reminders 327 through the system on the actions to follow, medication schedule, appointments. Patients may use the system to perform on need basis or on demand 329 calls to the care team.

The system generates alerts, for example, on situations where the vitals results are deviating from the set threshold limits based on each patient, or when abnormalities observed, for example, irregular heart rate that is higher (tachycardia) or lower (bradycardia) than normal resting rates condition or when patient is not adhering to the care schedules, lifestyle, activity, and nutrition. All the alerts are remain in the type they originated until the respective care team intervenes and necessary care is provided. The history of such alerts is stored in alert system 328 of the disclosed method and used to generate the time-based healthcare prognosis reports. The disclosed system has medication management 330, which consists of all medications prescribed to patient or counter medicines used by patient. With this history on medications inferences may be drawn, if any, for their effectiveness, resistances, reactions, and possibilities in finding comorbidities for cardiac healthcare prognosis. Healthcare practitioner or assigned care team member performs this at regular time intervals, to enable changes in medication for achieving quick recovery path and healthcare prognosis. All communications between care team and patient are facilitated adhering with communication protocols, for example HL7 interface, and recorded in the system 331. This includes communication of requests for diagnostic tests and submission of reports to the system. All communication history may be useful in assessment of effectiveness of respective function by care team towards healthcare prognosis of patient and involvement, interest and mindset of patient and integrating the third party test reports into the system. All web application administrative management and settings are addressed through 332. The assessments 334, in periodic way are generated and stored based on these assessments devised care module 335 is assessed and changes are incorporated, incase of need. The time schedule reports 336 are generated and all role based designated users 340 will access the reports for understanding healthcare progression and are stored in database 350. Role based assigned users can also access several combinations of regular query reports could be from the system for quick understanding and assessment of the monitoring process. All the patterns of workflow 333 is stored and assigned administrator from the users may access them for correctness, adherence to policies, deviations and audit purposes. The system works under security and all the process in the workflow is executed by native business logic specific to the system.

FIG. 5 illustrates a process for the management and prognosis of patient healthcare according to some embodiments of the disclosed subject matter. This is presented with four functions, such as phases 510, actions 520, business logic 530 and outcome 540 of proposed healthcare prognosis platform method. In the collect 512 phase the monitoring devices are activated to obtain and record physiological vital information at selective time intervals. For example, a heart rate sensor is placed on the patients body, the sensors on activation will start collecting the continuous information on patient heart rate. In transmit 514 the collected data packaged and delivered through connecting source securely to viewing source. For example, the collected heart rate information is sent via Bluetooth to the mobile application for immediate viewing. In evaluate 516 phase, thus transmitted vitals information is evaluated and reviewed with system and method indicators, like thresholds, and created algorithms complies the data for several combination of correlations. For example, several sets of correlations between the data collected and questioner responses in psychological and physiological from activity lifestyle, nutrition and others. Thus generated responses are stored and reviewed by healthcare practitioners. For example, the transmitted heart rate data continuously will get evaluated with the threshold value set for that patient at an averaging time set, like for every five minutes, now algorithm created will accordingly evaluate the continuous incoming data and sends to view and stores in database. From this process if any abnormalities observed from set thresholds, a survey question will get generated. In notify 518 phase alerts based on the evaluation changes to set rules may get prepared and such alerts get notified to the role based assigned care team and healthcare practitioner. For example, the abnormalities thus observed based on their risk gets populated onto the dashboard and get notified to all assigned responsible team members for necessary action. In intervene 518 phase assigned care team start acting by communicating with all the involved including patient and healthcare intervention, if need, would take place for corrective action in treating, educating and preparing patient on prognosis. For example, based on the notified alerts for the heart rate data designated care team member contacts the patient and reach out to the healthcare practitioner for necessary healthcare action. Once the intervention is completed based on the assessment out put the team starts educating the patient on care prognosis and prepares patient not occurring same sort of alert for the same scenario for the same vital (heart rate in this example) again.

The solution Prognosis defines as “the application of information and communications technologies across the whole range of functions that affect the health sector” and including “products, systems and services that go beyond Internet-based applications”.
Through this prognosis we can:
Screen or identify the patients
Measure their performance
Manage the care collaboratively

The system helps in:
Finding clinical evidences and its guidelines
Business rules to help create care plans
Performance management standards and rules for engagements on the platform for all stakeholders
Open Embedded end user system
Managed as an enterprise service for healthcare professionals, caregivers and other healthcare related service providers and implementers.

The significant benefit of this invention is with an Initiative that aims to increase use of technologies to:
Reduce the use of emergency department and hospital services by cardiac patients, remote patients and older adults (60+years old).
Enable independent living and the ability to live in the setting of one's choice.
Lead to improvements in the cost and quality of care.
Reduce the need for cardiac patients, remote patients and older adults to move to more intensive, high-cost care settings.
Reduce the burden on formal and informal caregivers.
Work in the home, as well as in long-term and pre & post-acute care settings.
These technologies include integrated and standalone remote monitoring devices for chronic disease management, post-acute care management, and patient safety monitoring for wandering and falls.
Chronic Disease Management (Currently focusing on cardiac ailment and obesity patients) and Post-Acute Care Management and Patient Safety

FIG. 6 illustrates progression of healthcare models existing to proposed as per disclosed subject matter. The existing model 610 may be categorized as provider centric model. Which is shown as organized by specialty and discrete services for any chronic disease silos including cardiac care by any provider solution. In the existing model, there is no learning and evidence based decision-making method and the care by one-provider 612 to another provider 612 can vary. The knowledge base is not utilized or changed based on scenarios and need. The whole process becomes stereotype in centrally controlled knowledge only. This process can even make the beneficiary go through unknown facts and can cause more cost and repetitive generic care model, decreasing the quality of healthcare.

The proposed method 620, is tailored, to collect data from patients in both active and passive way, wherever they are, and providers can realize benefits from reduced readmissions, to shortened hospital stay to improved clinical outcomes, to provide training to the specialists to be, to provide satisfaction to the involved patients and their attendants at large.

The process transformation will take place through the currently disclosed subject matter. This new model will provide coordinated care units across the chronic disease and will follow the essentials of change:
Community mobilization 626 that mobilizes available community resources to meet patients' needs
Health system redesign 624 the organization and culture, to provide the delivery of coordinated, high quality care with consists of self-management support that empowers and prepares patients to self manage their health and their healthcare, delivery system transformation, which is collaborative, multi-disciplinary teams using evidence based approaches to deliver clinical care and self-management support, evidence-based decision making in which the information, systems and tools to ensure clinical care is provided consistent with the best evidence-based available and integrated information systems, where Clinical and administrative Information systems to support multidisciplinary, collaborative teams providing evidence based care in a variety of care settings. It also helps patients to learn or get advise through the resources provided to them by the healthcare practitioners.

A greater proactive interaction 622 is created with improved and activated patients and prepared healthcare teams through this model of embodiment of the disclosed subject matter.

FIG. 7 illustrates high-level architecture of a real-time remote patient monitoring system according to some embodiments of the disclosed subject matter. The application is designed on integrated architecture comprising of presentation layer, business logic layer and data layer, which are physically separated. All the stages architecture relates to their structures, policies and procedures within a centralized system.

The presentation layer 710 provides user access to the system. This layer permits user to enter the data and/or automatic collection of data through integrated sensors 712-714, allows user to collect the data and presents data to the user. The web presentation 718 will be implemented using PHP framework, which will be running in web container of the application. The user interaction is through PHP pages. All information or request will be forwarded to the server through web or mobile APIs using SSL protocols for processing and/or storing in the secured database, using PHI table columns for encryption. The alerts and messages 716 are processed through API calls. The database access is provided through Virtual Private Network (VPN).

The business logic layer 720 consists of business and data rules, this helps in solving critical business problems and achieving productivity to its advantages. The components that make up this layer can exist on server machine 722-724 to assist resource sharing. The components can be used to enforce business and data rules. The load balancer 728 facilitates and eases the response time to all the business rules and/or data requests to manage to its execution. The load balancer, balances the server load on request of the users and maintains concurrent users. All the business logic components (PHP/Zend) will be hosted on application server. This layer will also interact with all external components used in the system.

The data layer 730 contains data and database 732 with procedures that is manipulated by the system. The data and database will have backup 734 and archival process. All database interaction will happen through the business layer. The database is replicated 736 to ease the retrieval response process for user requests and balance the load and help data security and availability.

The web and mobile based system is not only designed to network healthcare professional with their patients for creating better recovery path and reduce readmission and benefit the hospitals in reducing readmissions but will also enhance the credibility and reach of specialists to more areas and people, as a part of tele-medicine and e-visits. This will also enable specialist to get trained, with when, how, why, what questions of different combination of problem and solution scenarios, as this platform is open to the care team and specialist reactions, responses and care procedures are visible to entire team.

In addition, web and mobile based system and method of healthcare platform is designed to handle all the healthcare related data and communications in a secure way complying to HIPPA regulations and HL7 protocols within the system user environment and to and from outside third-party engaged parties.

Further, through the system and method is made suitable to find the comorbid nature of different components used in a executed healthcare plan and to alter or modify the plans to incorporate additional procedures to prevent the risks of such comorbid nature and to increase the efficiency of initial healthcare management plans for the cardiac disease in treatment.

The system and method disclosed provides unique platform which enables specialists and physicians from other healthcare provider services like clinics, home healthcare, assisted or independent living establishments, rehabilitation centers etc., to share the effect of comorbidities while treating patients for cardiac care with different other diseases and corresponding treatment plans. Thus generated information and knowledge will be more useful for R&D teams in drug discover groups and will greatly help the clinical trial teams while they conduct studies in different phases of trials.

The integrated system and method of real-time continuous remote patient monitoring will be more useful in collecting the healthcare prognosis related vital changes than current method of assessment based on weekly visit to the provider with a minimal or less follow up actions from care team and adherence to procedures mentioned during post-operative discharges for the cardiac patients. The proposed system and method is useful even to preparing the patients suitable for pre-operative procedures. Patients rather than having frequent, more commonly in alternate days, to clinics, the preparation procedure could be made functional from the patient homes reducing the anxiety to patients and families and related stress stigmas, that may have impact in the following disease recovery process.

In an another example embodiment of the disclosed subject matter, the system when used for clinical trials most of screenings could conducted remotely and collection of relevant vitals data can happen securely and stored for assessments and audits. This wealth of the data could be useful to drug discovery teams and sponsoring companies in understanding the immediate and gradual/stable reaction in favor or against to the drug/molecule in question. On the other hand this time stamped data and reports, when made available to regulators, will help in understanding the followed procedures in trials with corresponding continuous results on administered drugs.

Another example embodiment of the disclosed subject matter, relates to the community healthcare or primary healthcare. In current days of reducing resources in healthcare provider and specialists even in developed countries and major cities of almost all countries, the situation in availability of healthcare providers and specialists in developing or underdeveloped countries and small cities and remote areas is bleak. On the other hand the population living in small cities and remote areas of several countries are getting effected on health recovery and costs, at times this even impacts the payers. Employing this real-time remote health monitoring for cardiac and other chronic diseases treatment and recovery, would be of much help to all parties involved, first being patients and secondly payers. Another could be conducting general healthcare periodic check up for the remote and or distributed populations. This will enable government to have first hand continuous data on the disease prevalence patterns on low scale rather than having currently from sample sources, this will reduce the burden on healthcare expenditure.

The currently disclosed subject matter may be implemented with a verity combination of hardware and software or even hardware and manual combination, where the access to internet is having problem. When implemented as software based solution, the disclosure is implemented using all the means and functions described above.

The currently disclosed subject matter can be included as an software program for web or mobile or both platforms, either as computer usable media or mobile usable media in an article of manufacture or distribution during sales of such article.

The currently disclosed subject matter, according to certain embodiments, overall will help in providing improved healthcare and lowering costs, provide meaningful use of the vitals, which is a major issue today, in the following areas, like pre- and post-acute management of chronic conditions, post-acute patient stabilization, patient education and self-management, reduction in hospitalizations and hospital readmissions, patient satisfaction and better health, caregivers workload and efficiencies and reduced risk and liability for the care providers.

The figures shown are for merely representative for understanding the concept and are not drawn to scale. Certain functions or portions of representations may be exaggerated, while others may be minimized, this is not intentional or for misleading.

The disclosed subject matter is not to be limited in scope by the specific embodiments described herein. Various features are grouped together in a single embodiment for the purpose of justifying the disclosure.

1. A method of managing patients healthcare prognosis, comprising:
creating patient details with data for a entered patient;
creating details of a healthcare professional with a details on provider;
screening the patient based on the details;
developing a healthcare plan for assessment for a patient for a health effect;
creating at least to collect one vital data for a patient;
assessing the condition of patient based upon inferences from, the gathered vital data, with their time-based variations and physiological and psychological data collected from the screening and reviews;
evaluate the correlation complexities from the inference for a prognosis pattern to follow for a patient, for at least one criteria, to determine healthcare management plan;
create plan for a patient based on the management plan for at least one feature with goals;
system with integrated data collection transmission, storage and display to the web and mobile application gateway;
system with capability to execute correlation for at least one patient with different sets of data for at least one condition;
system with capabilities to communicate securely for at least one feature with others;
system with capabilities to generate time based report for at one patient based on at least one criteria of healthcare plan;
system that provide recommendation based on healthcare management and records with patent details;
system that provide intervention capabilities with implementation of recommendations for at lease one scenario of prognosis for at least one disease.

2. The method of claim 1, wherein patient details include at least one, age, sex, ethnicity, activity, job duties, place of work, food habits, a photograph, weigh gain or loss ratios.

3. The method of claim 1, wherein patient details further includes past medical history or conditions.

4. The method of claim 1, wherein patient details further includes information patient immediate family medical history.

5. The method of claim 1, wherein patient details further includes information on past places of stay, if any and nature of nearby environment.

6. The method of claim 1, wherein professional details further includes at least one of provider name, address, professional name, phone number, mail contact address or specialty.

7. The method of claim 1, wherein screening further includes at least one professional test or consultation and at least one meaningful result or note is entered in patient details.

8. The method of claim 1, wherein developing healthcare plan further includes devising different stages treatment with vital collection frequencies.

9. The method of claim 1, wherein developing healthcare plan further includes conditions on stages of plan to operate and what to expect as outcome.

10. The method of claim 9, wherein developing healthcare plan further includes the assessment of outcome.

11. The method of claim 1, wherein vital data collection further includes the selection of any one of the passive or active sensors for the parameter selected to deploy on patient body to record data.

12. The method of claim 11, wherein parameter further includes at least one of the, temperature, heart rate, blood pressure, weight, blood oxygen, blood glucose, sleep pattern, sleep apnea, activity, calorie intake, water intake and food label.

13. The method of claim 1, wherein data transmission further includes encrypted data transmitted through paired Bluetooth mode or in some cases through location based wi-fi to storages.

14. The method of claim 1, wherein execution of correlations further includes continuous vitals data at different stages of healthcare management drawn to processors for generating the correlations patterns for requested active or passive mode of collected data.

15. The method of claim 1, wherein communicate securely further includes perform at least one of the actions like prescription changes, messages, alerts, family social group exchanges, healthcare professional e-visit, call notes and third-party requests, results and reports are communicated employing the HIPAA guidelines, PHI data and HL7 protocols.

16. The method of claim 1, wherein intervention capabilities further includes healthcare team reaching out to patient for assessing the situation and providing immediate medical help to control or cure recorded patient abnormalities arisen during implementation of healthcare prognosis plan for treatment of disease.

17. The web and mobile based integrated system of claim 1, when used for community health data collection at and by local, regional, national level or on large scale by industries, the generated data present lot of correlation scenarios to evaluate and arrive to best way of controlling the rate of prevalence of diseases and their comorbidity behavior. This result helps drug discovery groups, clinical trial conducting organizations, health organizations of national and international level to help make the plans, policies and budgets.

18. The web and mobile based integrated system of claim 1, where in the having facility collecting real-time continuous data and secure data delivery for remote patient monitoring use could be further enhanced, if used by the drug clinical trial organizations, as this will help the clinical trial groups to enhance the effectiveness of evaluation and audit for the trial study results and reduces the time in managing the large groups of trial teams and launch of new drugs while the regulatory groups gets benefited with traceable time stamped data and reports.

19. The system and method with integrated web and mobile based platform having all the features, abilities to collect, transmit, evaluate, notify and intervene as major with many recorded herein sub or minor features and capabilities, with the secure communication, medication management and workflow performing on integrated architecture wrapped with security and services features, presented herein and with reference to above mentioned description and drawings.
